(19) United States
(12) Patent Application Publication
(10) Pub. No.: US 2026/0153131 A1
(43) Pub. Date: Jun. 4, 2026

(54) TORSIONAL VIBRATION ISOLATED COUPLING ELEMENT

(71) Applicant: Hasse & Wrede GmbH, Berlin (DE)

(72) Inventors: Sebastian Willeke, Berlin (DE); Michael Steidl, Berlin (DE); Norbert Reinsperger, Hoppegarten (DE); Stephan Bohmeyer, Hoppegarten (DE)

(73) Assignee: Hasse & Wrede GmbH, Berlin (DE)

(21) Appl. No.: 19/123,266

(22) PCT Filed: Oct. 20, 2023
(86) PCT No.: PCT/EP2023/079242

§ 371 Date: Apr. 22, 2025

(30) Foreign Application Priority Data
Oct. 24, 2022 (DE) 10 2022 128 006.3

(51) Int. Cl. F16D 7/04; F16D 3/12; F16D 3/50

(52) U.S. Cl. CPC F16D 7/048; F16D 3/12; F16D 3/50

(57) ABSTRACT

A torsional vibration-isolated coupling element with a rotation axis comprising an outer ring as the input side of the coupling element, an inner ring as the output side of the coupling element, and at least one energy storage unit with at least one energy storage element, wherein the torsional vibration-isolated coupling element has a non-linear torsional stiffness.

### BACKGROUND AND SUMMARY

The present invention relates to a torsional vibration-isolated coupling element as claimed in the preamble of claim 1.

Torsional vibration-isolated coupling elements of this kind are used for reducing undesired torsional vibrations in a large number of different applications, such as in the drive trains of motor vehicles, ships, piston compressors, piston pumps or in stationary power plants for generating energy, for example.

What are known as a genset motors are used for the last-mentioned applications, these having, in contrast to mobile passenger car or truck drives, a largely stationary operating point with a constant rotation speed and a virtually constant load torque. The current prior art predominantly provides couplings having a linear spring characteristic for this purpose. Here, the constant positive torsion spring stiffness is usually dimensioned on the basis of the drive torque to be transmitted. However, torsional vibrations (e.g. due to fluctuations in the torque) are also transferred owing to this torsional stiffness of the drive train.

### DISCLOSURE OF THE INVENTION

In order to be able to transmit the static drive torque at the stationary operating point without undesired fluctuations in torque, a non-linear torsional stiffness with a depressive spring characteristic is required. Here, the torsional moment initially increases as the torsion angle of the coupling element increases, until a virtually constant torque level is reached at the stationary operating point (QZS quasi-zero stiffness isolator). The negligible torsional stiffness at the operating point results in optimum isolation of the rest of the drive train from undesired torsional vibrations.

In order to implement such a degressive spring characteristic, the linear torsion spring element usually already present in the drive train (e.g. a rubber coupling with a constant positive torsional stiffness) is supplemented by a non-linear torsion spring element connected in parallel. Here, the non-linear torsion spring element has a torsional stiffness which is dependent on the relative torsion or the torsion angle of the coupling element. Here, the non-linear spring characteristic has a negative stiffness in the angular range of the stationary operating point, the absolute value of the negative stiffness corresponding to the value of the constant positive torsional stiffness of the linear spring element. The parallel connection of the two spring elements therefore results in a negligible torsional stiffness at the operating point.

For practical implementation of such torsional vibration isolation, a non-linear coupling element with a negative torsion spring stiffness is required at the operating point. Concepts for implementing negative torsional stiffnesses are proposed, for example, for increasing the energy efficiency of actuators which can be used for deformation of aerofoil structures in the aviation sector. Apart from basic design concepts, no technical implementation of a negative torsional stiffness has been known for use in drive trains up to now.

The invention is therefore based on the object of providing an improved torsional vibration-isolated coupling element which meets both requirements, specifically the transmission of the static torque and at the same time the broadband isolation of the drive train, and additionally no longer has the disadvantages of an increased installation space requirement and a limited frequency or rotation speed range, or at least significantly reduces them.

This object is achieved by a torsional vibration-isolated coupling element having the features of independent claim 1.

Against the background of the described QZS quasi-zero stiffness concept for torsional vibration isolation, one concept of the invention involves the implementation of a non-linear coupling element with a negative torsional stiffness.

Accordingly, a torsional vibration-isolated coupling element with a rotation axis comprises an outer ring as the input side of the coupling element, an inner ring as the output side of the coupling element, and at least one energy storage unit with at least one energy storage element. The torsional vibration-isolated coupling element has a non-linear torsional stiffness.

The present invention presents a coupling concept for implementing a non-linear torsion spring characteristic with a negative torsional stiffness. One possible application of the coupling element is the described torsional vibration isolation (quasi-zero stiffness concept) of drive trains in combination with an existing coupling element with a positive torsional stiffness. Here, the concept meets, in particular, the requirement of a negative torsional stiffness in a limited angular range (in particular in the region of the stationary operating point).

One particular advantage here is that the proposed coupling element is distinguished from alternative concepts for implementing negative torsional stiffnesses, which are based on magnetic operating principles for example, by a very simple mechanism having purely mechanical components. Therefore, the concept benefits from simplified design, assembly and manufacturability, in addition to low manufacturing costs.

The term “energy storage element” is to be understood to mean not only springs, such as compression springs for example, but also alternatives, such as compressed-air springs with a variable pressure as the preloading, gas compression springs, hydraulic springs and the like, for example.

One embodiment makes provision for the non-linear torsional stiffness of the torsional vibration-isolated coupling element to have a very low or a negligible torsional stiffness, in particular the value zero, at an operating point owing to the combination of a positive torsional stiffness and a negative torsional stiffness. In this way, optimum isolation of the rest of the drive train from undesired torsional vibrations advantageously results from the negligible torsional stiffness at the operating point.

In one embodiment, the negative torsional stiffness is formed by the compression of the at least one energy storage element of the at least one energy storage unit, wherein the at least one energy storage element is a radially arranged translational compression spring, which is in contact with a profile of the outer ring, the profile running in the circumferential direction.

The compression spring can, of course, also be a compressed-air spring with a variable pressure as the preloading, a gas compression spring, a hydraulic spring or the like.

It is advantageous here for the non-linearity of the torsional stiffness (i.e. the variation in the torsional stiffness with the torsion angle of the coupling) to be achieved substantially by the compression of the at least one radially arranged translational compression spring corresponding to a profile running in the circumferential direction.

Within the specified torsion angle range of the coupling element, this principle provides the greatest possible flexibility in terms of the design of the non-linear spring characteristic owing to the virtually unlimited number of possible profile geometries. If the profile geometry is defined, the variation in the spring preloading allows subsequent adjustment of the spring characteristic.

A further embodiment makes provision for the outer ring of the coupling element and the inner ring of the coupling element to be coupled via the at least one energy storage unit, wherein the outer ring of the coupling element and the inner ring of the coupling element are arranged coaxially in relation to each other and to the rotation axis. This results in an advantageously compact design.

In an alternative embodiment, the negative torsional stiffness is formed by the compression of the at least one energy storage element of the at least one energy storage unit, wherein the at least one energy storage element is an axially arranged translational compression spring, which is in contact with a profile of the outer ring, the profile running in the longitudinal direction of the rotation axis. This is advantageous since there is no variation in the preloading of the compression spring due to the rotation speed-dependent centrifugal force.

Provision is made here for the outer ring of the coupling element and the inner ring of the coupling element to be coupled via the at least one energy storage unit, wherein the outer ring of the coupling element and the inner ring of the coupling element are arranged axially one behind the other in the direction of the rotation axis. There is advantageously no variation in the preloading of the compression spring due to the rotation speed-dependent centrifugal force here either.

The axially arranged translational compression spring may also be in the form of a compressed-air spring with a variable pressure as the preloading, a gas compression spring, a hydraulic spring or the like.

In a yet further embodiment with the radially arranged compression spring, it is additionally advantageous when an intermediate space is formed between an internal lateral surface of the outer ring and an outer lateral surface of the inner ring since the compact design is further improved in this way.

For this purpose, provision is made in one embodiment for the outer ring to have, on the internal lateral surface, the profile with a profile contour, wherein the profile projects from the internal lateral surface of the outer ring into the intermediate space. This is advantageous since a yet further improvement in the compact design can be achieved in this way.

It is additionally advantageous here when the profile contour of the profile of the outer ring is in the form of a harmonic profile contour, for example with a cosinusoidal profile. It is, of course, possible for other profiles to also be used, such as a trapezoidal profile etc., for example.

The configuration of the profile contour advantageously allows any desired spring characteristics to be implemented. In addition, it is possible for either identical or different spring characteristics to be implemented for the two rotation directions of the coupling element by means of symmetrical or asymmetrical profile contours. Owing to the flexible profile contour, the negative torsional stiffness is not restricted to a specific angular range, but rather can also be designed for several successive angular ranges. Optimal torsional vibration isolation for several different operating points is possible as a result.

For advantageous coupling between the internal lateral surface of the outer ring and its profile, provision is made for the at least one energy storage unit to be in contact either with the internal lateral surface of the outer ring or with the profile by way of its profile contour depending on a relative angle about the rotation axis between the outer ring and the inner ring.

In a further embodiment, the at least one energy storage unit comprises at least one compression spring, one preloading element with a center axis, and one contact element, wherein the at least one energy storage unit is arranged with the at least one compression spring and a portion of the preloading element in the inner ring in a receiving space in the direction of the center axis and therefore in the radial direction with respect to the rotation axis. This design is advantageously simple and compact.

The compression spring may also be a compressed-air spring with a variable pressure as the preloading, a gas compression spring or the like in this case.

In a further embodiment, the at least one compression spring, by way of a first spring end, is in connection or in contact with the preloading element, wherein a second spring end of the at least one compression spring is in the form of the contact element or is connected to the contact element, and wherein the at least one compression spring pushes the contact element against the internal lateral surface of the outer ring or the profile. Only a few components, the assembly of which can likewise be simple, are advantageously required for this purpose.

In an alternative embodiment, it is also possible for the profile, in the case of the radially arranged (radial) translational spring/springs, to be arranged both on the inner side of the outer ring and also on the outer side of the inner ring. In the latter case, the energy storage unit is then located in the outer ring.

In the alternative embodiment with (an) axially arranged translational spring/springs, the profile is arranged to the left or to the right of the energy storage unit in the axial direction.

In another embodiment, a preloading of the at least one compression spring can be set by adjusting the preloading element. Owing to the variable spring preloading, advantageous adaptation to different applications and operating states is also possible subsequently.

It is advantageous when the contact element is a rolling body, in particular a ball since, in this way, only little rolling friction occurs and wear is reduced owing to the rolling body. Angular compensation of the rotation axes is also rendered possible. The rolling body may also be, for example, a cylindrical roller.

In another embodiment, the torsional vibration-isolated coupling element further has at least two energy storage units. Here, it is advantageous for the at least two energy storage units to be arranged symmetrically in the coupling element. One advantage here is that the radial pressure forces of opposite compression springs compensate for each other. Therefore, no resulting radial force occurs between the inner ring and the outer ring.

In a yet further embodiment, the coupling element is a coupling element of a drive train of an application operated under steady-state conditions, in particular a drive train of a combustion engine operated under steady-state conditions.

Owing to the torsional vibration isolation and the resulting reduced torsional load on the drive train, the demands placed on the individual components in respect of vibration are reduced. Furthermore, additional components, which are usually required for reducing torsional vibrations, can be dispensed with. The costs of these additional components and the required installation space are therefore reduced. In contrast to comparable torsion spring concepts, the stiffness characteristics of which can usually be varied only in a limited parameter range, the invention described below allows an extremely wide variety of spring characteristics to be implemented and subsequently modified by means of a variable spring preloading owing by taking into consideration a freely configurable profile contour.

Further advantageous embodiments of the invention can be found in the dependent claims.

### SUMMARY OF THE DRAWINGS

Some exemplary embodiments of the invention will be described below with reference to the appended drawings. The invention is not limited to these exemplary embodiments. In particular, individual features of the following exemplary embodiments can be used not only with these, but also with other exemplary embodiments. In the drawings:

FIGS. 1-5: show schematic illustrations of an exemplary embodiment of a torsional vibration-isolated coupling element according to the invention in various positions;

FIG. 6: shows a schematic perspective view of a further exemplary embodiment;

FIG. 7: shows a schematic sectional view of the further exemplary embodiment according to FIG. 6;

FIG. 8: shows an enlarged schematic illustration of the region VIII from FIG. 7; and

FIGS. 9-10: show graphical illustrations of spring characteristics.

In the text which follows, terms such as “outer” or “inner” refer to the respective drawing plane and “axial” and “radial” refer to a rotation axis 1a of a torsional vibration-isolated coupling 1.

### DETAILED DESCRIPTION OF THE DRAWINGS

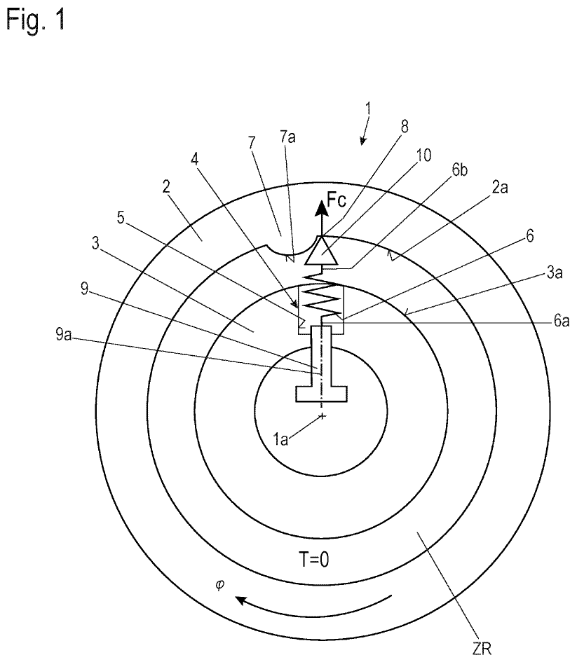

FIG. 1 shows a schematic radial sectional view of an exemplary embodiment of a torsional vibration-isolated coupling element 1 according to the invention in a starting position.

The torsional vibration-isolated coupling element 1 has a first rotation axis 1a. The coupling element 1 comprises an outer ring 2 as the input side having a central recess with an internal lateral surface 2a, an inner ring 3 as the output side, e.g. in the form of a hub, and an energy storage unit 4.

The outer ring 2 and the inner ring 3 are arranged concentrically in relation to the rotation axis 1a of the coupling element 1 and can be rotated with respect to each other through a relative angle φ about the rotation axis 1a.

The inner ring 3 is arranged in the recess in the outer ring 2.

An intermediate space ZR is formed between the internal lateral surface 2a of the outer ring 2 and an outer lateral surface 3a of the inner ring 3.

The outer ring 1 has a profile 7 on the internal lateral surface 2a. The profile 7 projects from the internal lateral surface 2a into the intermediate space ZR. The profile 7 has a profile contour 7a.

The energy storage unit 4 comprises an energy storage element, which is in the form of a compression spring 6, a preloading element 9 with a center axis 9a, and a contact element 10. The energy storage unit 4 is arranged or translationally mounted with the compression spring 6 and a portion of the preloading element 9 in the inner ring 3 in a receiving space 5 in the direction of the center axis 9a and therefore in the radial direction with respect to the rotation axis 1a.

The term “energy storage element” is to be understood to mean not only springs, such as compression springs for example, but also alternatives, such as compressed-air springs with a variable pressure as the preloading, gas compression springs, hydraulic springs and the like, for example.

The compression spring 6 is, by way of a first spring end 6a which in the region of a base of the receiving space 5, the base facing the rotation axis 1a, connected to the preloading element 9, e.g. to a screw, fastened thereto or is in contact with the preloading element 9.

A second spring end 6b of the compression spring 6 is in the form of the contact element 10 or is connected to the contact element 10. The compression spring 6 pushes the contact element 10 against the internal lateral surface 2a of the outer ring.

The contact element 10 is shown here with a triangular cross section and extends parallel to the rotation axis 1a over a specific length portion of the internal lateral surface 2a of the outer ring 2 in the axial direction of the rotation axis 1a. The contact element 10 may, of course, also have a point-to-point contact portion.

In this way, the compression spring 6, either by way of its second spring end 6b as contact element 10 or via the contact element 10 itself, makes contact with the internal lateral surface 2a of the outer ring 1 at a contact point 8 or contact portion. The preloading of the compression spring 6 can be increased or reduced by tightening or loosening the preloading element 9 (screw).

In the starting position (relative angle φ=0) of the coupling element 1 shown in FIG. 1, the normal contact force Fc in the radial direction occurs at the contact point 8.

This normal contact force Fc corresponds to the preloading force of the compression spring 6 exerted by the preloading element 9 (screw).

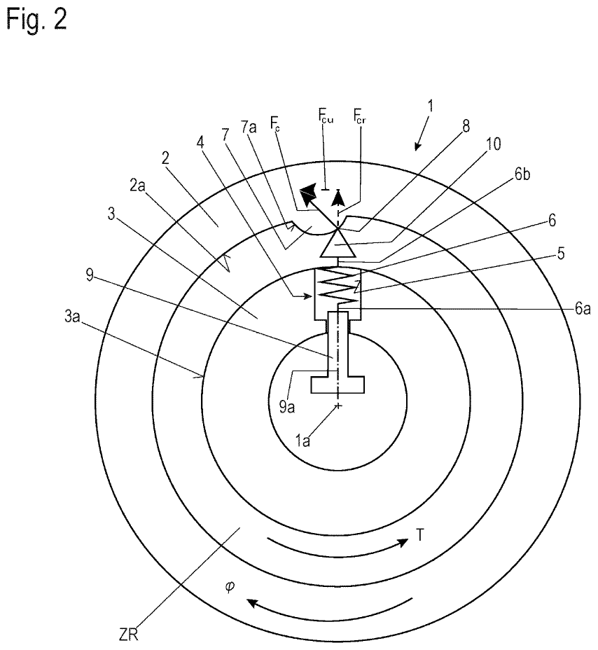

FIG. 2 shows the schematic radial sectional view of the first exemplary embodiment according to FIG. 1 in a position rotated out of the starting position.

The relative angle q is now increased in relation to its value 0 in the starting position, i.e. the outer ring 2 has rotated e.g. in relation to the inner ring 3 in the clockwise direction.

If the relative angle φ is increased as shown in FIG. 2, the contact point 8 follows the profile contour 7a of the profile 7 of the outer ring 1.

The compression spring 6 is then compressed by the radial displacement of the contact point 8 in the direction of the rotation axis 1a in such a way that the force of the compression spring 6 increases.

In addition, a radial force component Fer and a circumferential force Fcu result from the resolution of the normal contact force Fc on the flank of the profile contour 7a of the profile 7. The circumferential force Fcu leads to a torsional moment T, which counteracts the relative rotation through the relative angle q (positive torque). This increase in the opposite torque T (in the counterclockwise direction in FIG. 2) with an increase in the relative angle φ corresponds to a positive torsional stiffness. The resolution of the normal contact force Fc or the resulting torsional stiffness is influenced by the geometry of the profile contour 7a of the profile 7 depending on the relative angle φ. The magnitude of the normal contact force Fc or its force components Fcr and Fcu is additionally dependent on the preloading force of the preloading element 9.

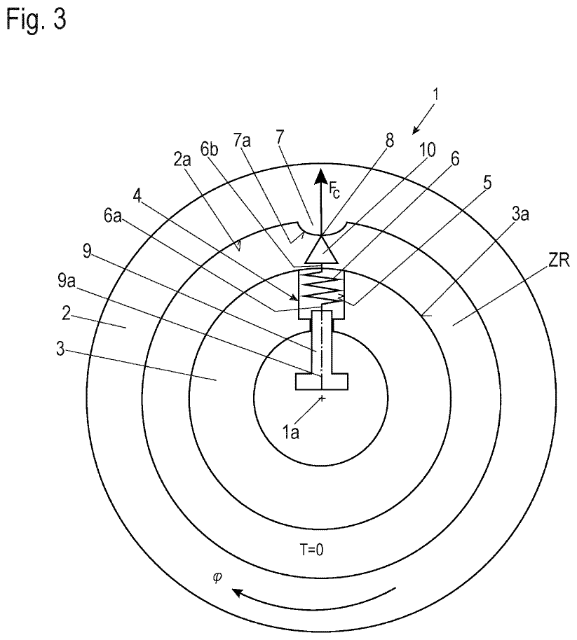

If the relative angle φ is increased further, the contact point 8 reaches the apex point of the profile 7, as illustrated in FIG. 3.

In this case, the compression spring 6 is compressed to the maximum extent in the direction of the rotation axis 1a, and therefore the resulting compression force reaches its maximum value. Here, the compression of the compression spring 6 corresponds to the radial dimension or the height of the profile contour 7a of the profile 7, i.e. the distance of the apex of the profile 7 from the internal lateral surface 2a of the outer ring 2.

On account of the radially acting normal contact force Fc, no force component circumferential force Fcu and thus no torque (T=0) occurs. This reduction in the torsional moment T with an increasing relative angle φ corresponds to a negative torsional stiffness.

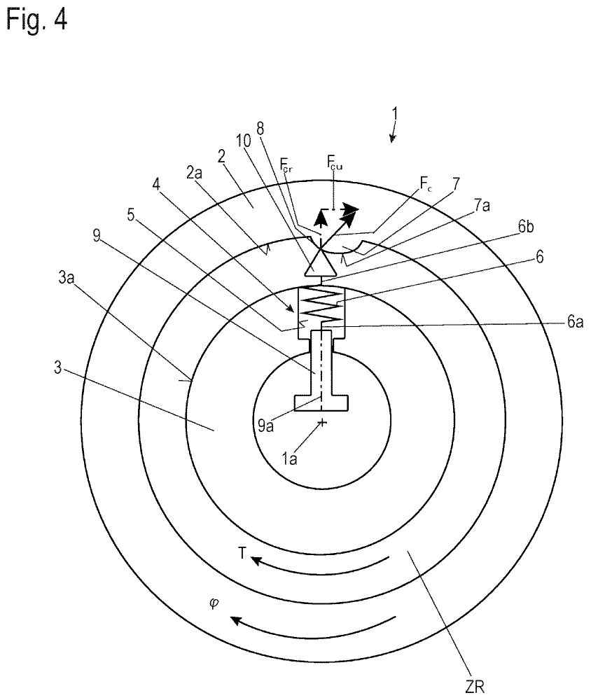

If the relative angle φ is increased further as shown in FIG. 4, the contact point 8 continues to follow the profile 7 and the compression spring 6 is relived of load again.

As a consequence of the force resolution at the flank of the profile 7, a force component circumferential force Fcu of the contact force occurs once again, but opposite to the circumferential force Fcu in FIG. 2. This opposite circumferential force Fcu results in a torque T, which this time however acts in the direction of the relative angle φ (negative torque), that is to say in the clockwise direction in FIG. 4.

The dependence of the negative torsional stiffness of the relative angle φ is influenced by the geometry of the profile contour 7a of the profile 7 or the force resolution. In addition, the absolute magnitude of the negative torsional stiffness is dependent on the potential energy stored in the compression spring 6 or the spring preloading by the preloading element 6.

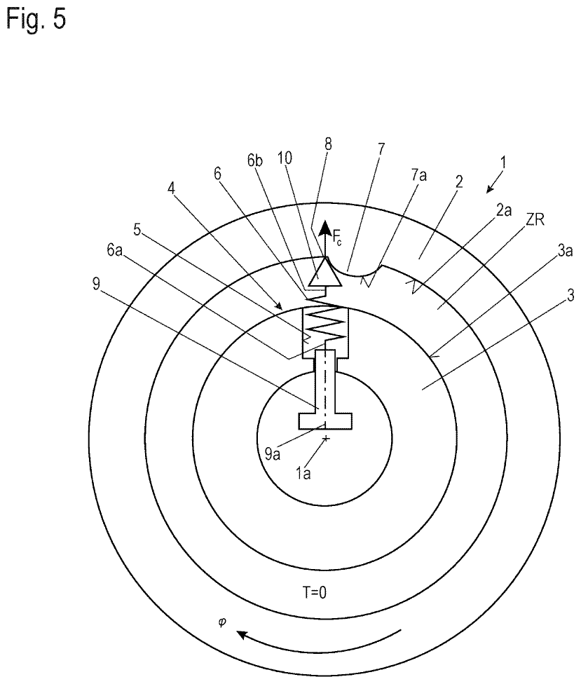

Finally, the contact point 8 reaches the non-profiled portion of the internal lateral surface 2a of the outer ring 2, as illustrated in FIG. 5.

Only the radial normal contact force Fc already shown in the starting position in FIG. 1, and therefore no torque T, occurs.

In other words, the energy storage unit 4 is in contact either with the internal lateral surface 2a of the outer ring 2 or with the profile 7 by way of its profile contour 7a depending on the relative angle φ about the rotation axis 1a between the outer ring 2 and the inner ring 3.

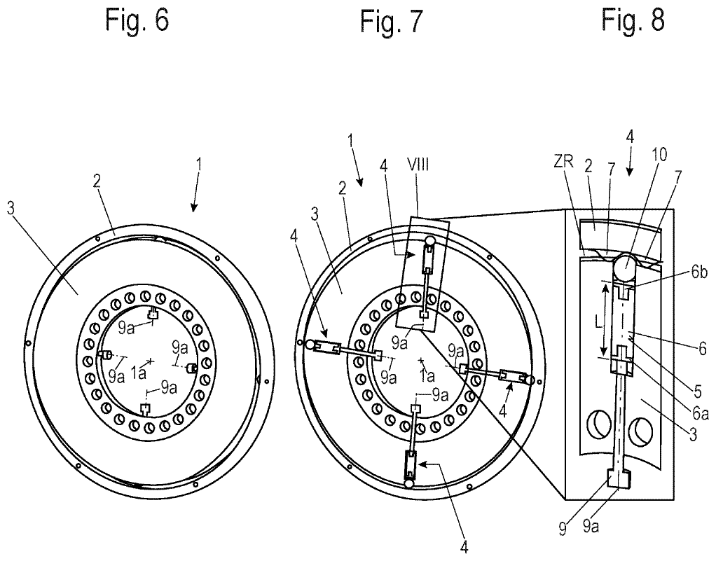

FIG. 6 shows a schematic perspective view of a further exemplary embodiment of the torsional vibration-isolated coupling element 1. FIG. 7 shows a schematic sectional view of the further exemplary embodiment according to FIG. 6. It shows a radial section in the region of the energy storage units 4. FIG. 8 shows an enlarged schematic illustration of the region VIII from FIG. 7.

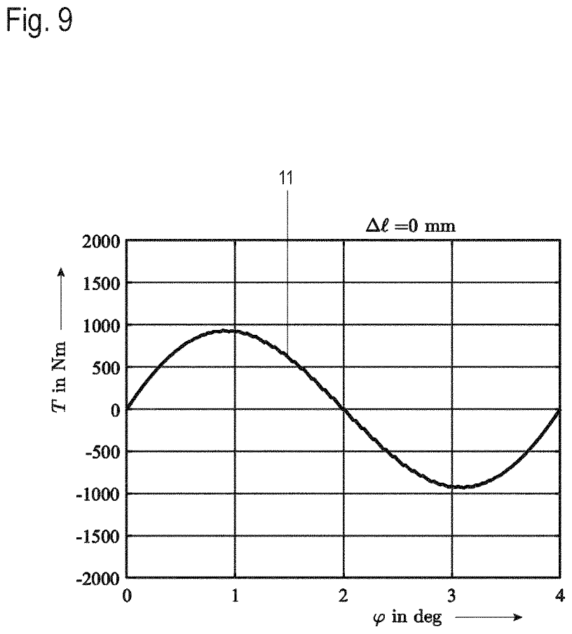

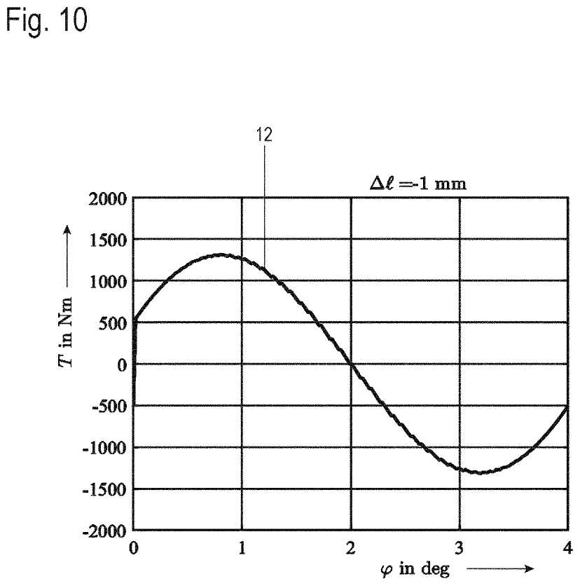

FIGS. 9-10 show graphical illustrations of spring characteristics.

The further exemplary embodiment of the coupling element 1 has four energy storage units 4, each having a compression spring 6 and a loading element 9. The four energy storage units 4 are arranged at 90°-angle intervals about the rotation axis 1a. More or fewer (e.g. two energy storage units 4) than four energy storage units 4 may, of course, also be provided.

The contact between the profile contour 7a of the profile 7 and the compression spring 6 is implemented here via a rolling body as the contact element 10. The spring ends 6a und 6b are in the form of plate-like components here. Therefore, the rolling body as the contact element 10 is not impeded on the plate-like component of the spring end 6b as the rolling body rolls on the profile contour 7a of the profile 7.

The rolling body may be, for example, a ball, a cylinder or the like.

A spring length of the compression spring 6 is denoted by the letter “1” here.

The resulting torsion spring characteristic of the torsional vibration-isolated coupling element 1 is shown, by way of example, in FIGS. 9 and 10 (FIG. 9, characteristic 11) and (FIG. 10, characteristic 12) for a harmonic profile contour (cosinusoidal profile) on the outer ring 2 and various preloadings or screw-in depths of the preloading element 9.

A torque T is plotted with respect to the relative angle φ in both of FIGS. 9 and 10.

Here, a preloading is implemented by a difference in length Δl of the spring length l of the compression spring 6: in FIG. 9: Δl=0 mm, in FIG. 10: Δl=−1 mm. The negative number indicates compression of the compression spring 6.

It can be seen that the magnitude of the negative torsional stiffness can be increased by increasing the preloading (or the available potential energy of the compression spring 6). In addition, the profile contour 7a of the profile 7, the profile contour being symmetrical with respect to the starting position (see FIG. 1), ensures that the coupling element 1 has an identical rotation spring characteristic for the two rotation directions about the rotation axis 1a.

Owing to the symmetrical arrangement of the four energy storage units 4 with the compression springs 6 in the circumferential direction with corresponding profiles 7a on the internal lateral surface 2a of the outer ring 2, the radial pressure forces of opposite compression springs 6 compensate for each other. Therefore, no resulting radial force occurs between the inner ring 3 and the outer ring 2.

In contrast to alternative concepts for implementing negative torsional stiffnesses, which are based on magnetic operating principles for example, the torsional vibration-isolated coupling element 1 described above is distinguished by a very simple mechanism having purely mechanical components.

Therefore, the concept also benefits from simplified design, assembly and manufacturability, in addition to low manufacturing costs. Furthermore, owing to the variable spring preloading of the compression spring 6, advantageous adaptation to different applications and operating states is also possible subsequently.

The configuration of the profile contour 7a of the profile 7 on the internal lateral surface 2a of the outer ring 2 allows any desired spring characteristics to be implemented.

In addition, it is possible for either identical or different spring characteristics to be implemented for the two rotation directions of the coupling element 1 by means of symmetrical or asymmetrical profile contours 7a. Owing to the flexible profile contour 7a, the negative torsional stiffness is not restricted to a specific angular range, but rather can also be designed for several successive angular ranges. Optimal torsional vibration isolation for several different operating points is possible as a result.

The invention can be modified within the scope of the appended claims.

In an embodiment that is not shown but can be easily imagined, the energy storage unit is arranged axially in the direction of the rotation axis 1a. Here, the at least one energy storage element is in the form of a translational compression spring 6 which is arranged axially on the inner ring 3 and is in contact with a profile 7 of the outer ring 2, the profile running in the longitudinal direction of the rotation axis 1a. It is, of course, also possible for the axially arranged translational compression spring 6 to be located on the outer ring 2 and to be in contact with a profile 7 arranged on the inner ring 3.

Here, the profile 7 is located respectively on the left or right of the compression spring 6.

The axially arranged compression spring 6 provides the advantage that there is no variation in the preloading of the compression spring 6 due to the rotation speed-dependent centrifugal force.

Here, the outer ring 2 of the coupling element 1 and the inner ring 3 of the coupling element 1 are coupled via the at least one energy storage unit 4, wherein the outer ring 2 of the coupling element 1 and the inner ring 3 of the coupling element 1 are arranged axially one behind the other in the direction of the rotation axis 1a.

It is, of course, possible for other profiles 7 to be used too. Such a profile 7 may be trapezoidal, for example.

LIST OF REFERENCE SIGNS

| | |
|---|---|
| Coupling element | 1 |
| Rotation axis | 1a |
| Outer ring | 2 |
| Lateral surface | 2a |
| Inner ring | 3 |
| Outer lateral surface | 3a |
| Energy storage unit | 4 |
| Receiving space | 5 |
| Compression spring | 6 |
| Spring end | 6a, 6b |
| Profile | 7 |
| Profile contour | 7a |
| Contact point | 8 |
| Preloading element | 9 |
| Center axis | 9a |
| Contact element | 10 |
| Characteristic | 11, 12 |
| Normal contact force | Fc |
| Force component | Fcr; Fcu |
| Spring length | 1 |
| Torque | T |
| Intermediate space | ZR |
| Relative angle | φ |

1.-16. (canceled)

17. A torsional vibration-isolated coupling element with a rotation axis comprising:
an outer ring as the input side of the coupling element,
an inner ring as the output side of the coupling element, and
at least one energy storage unit with at least one energy storage element, wherein the torsional vibration-isolated coupling element has a non-linear torsional stiffness.

18. The torsional vibration-isolated coupling element according claim 17, wherein the non-linear torsional stiffness of the torsional vibration-isolated coupling element has a negligible torsional stiffness at a first operating point as a result of the combination of a positive torsional stiffness and a negative torsional stiffness.

19. The torsional vibration-isolated coupling element according claim 17, wherein the non-linear torsional stiffness of the torsional vibration-isolated coupling element is zero as a result of the combination of a positive torsional stiffness and a negative torsional stiffness.

20. The torsional vibration-isolated coupling element according to claim 18, wherein the negative torsional stiffness is formed by the compression of the at least one energy storage element of the at least one energy storage unit.

21. The torsional vibration-isolated coupling element according to claim 20, wherein the at least one energy storage element is a radially arranged translational compression spring, wherein the at least one energy storage element is in contact with a profile of the outer ring, the profile having a circumference.

22. The torsional vibration-isolated coupling element according to claim 20, wherein the outer ring of the coupling element and the inner ring of the coupling element are coupled by the at least one energy storage unit, wherein the outer ring of the coupling element and the inner ring of the coupling element are arranged coaxially in relation to each other and to the rotation axis.

23. The torsional vibration-isolated coupling element according to claim 20, wherein the negative torsional stiffness is formed by the compression of the at least one energy storage element of the at least one energy storage unit, wherein the at least one energy storage element is an axially arranged translational compression spring, wherein the at least one energy storage unit is in contact with a profile of the outer ring, the profile running in the longitudinal direction of the rotation axis.

24. The torsional vibration-isolated coupling element according to claim 17, wherein the outer ring of the coupling element and the inner ring of the coupling element are coupled by the at least one energy storage unit, wherein the outer ring of the coupling element and the inner ring of the coupling element are arranged axially with the at least one other ring of the coupling element behind the at least one inner ring of the coupling element in the direction of the rotation axis.

25. The torsional vibration-isolated coupling element according to claim 17, wherein an intermediate space is formed between an internal lateral surface of the outer ring and an outer lateral surface of the inner ring.

26. The torsional vibration-isolated coupling element according to claim 25, wherein the outer ring has at least one contoured profile on the internal lateral surface, wherein the at least one contoured profile projects from the internal lateral surface of the outer ring into the intermediate space.

27. The torsional vibration-isolated coupling element according to claim 26, wherein the at least one contoured profile of the outer ring is harmonic.

28. The torsional vibration-isolated coupling element according to claim 26, wherein the at least one contoured profile of the outer ring is cosinusodial.

29. The torsional vibration-isolated coupling element according to claim 26, wherein the at least one energy storage unit is in contact with at least one of the internal lateral surface of the outer ring and the at least one contoured profile, depending on a relative angle about the rotation axis between the outer ring and the inner ring.

30. The torsional vibration-isolated coupling element according to claim 17, wherein the at least one energy storage unit comprises:
at least one compression spring,
one preloading element with a center axis, and
one contact element,
wherein the at least one energy storage unit is arranged with the at least one compression spring and a portion of the preloading element in the inner ring in a receiving space in the direction of the center axis and in the radial direction with respect to the rotation axis.

31. The torsional vibration-isolated coupling element according to claim 30, wherein:
a first spring end of the at least one compression spring is in at least one of in connection and in contact with the preloading element, and
a second spring end of the at least one compression spring is at least one of in the form of the contact element and is connected to the contact element, and
the at least one compression spring pushes the contact element against the internal lateral surface of at least one of the outer ring and the at least one contoured profile.

32. The torsional vibration-isolated coupling element according to claim 31, wherein a preloading of the at least one compression spring can be set by adjusting the preloading element.

33. The torsional vibration-isolated coupling element according to claim 30, wherein the contact element is at least one of a rolling body and a ball.

34. The torsional vibration-isolated coupling element according to claim 17, further having at least two energy storage units arranged symmetrically in the coupling element.

35. The torsional vibration-isolated coupling element according to claim 17, wherein the coupling element is a coupling element of a drive train of an application operated under steady-state conditions.

36. The torsional vibration-isolated coupling element according to claim 35, wherein the coupling element is a drive train of at least one of a combustion engine, a piston compressor and a piston pump operated under steady-state conditions.
